(19) United States
(12) Patent Application Publication
(10) Pub. No.: US 2019/0222799 A1
(43) Pub. Date: Jul. 18, 2019

(54) CABLE INTERFACE ENHANCING DEVICES AND METHOD

(71) Applicant: InVisions Technology Int. Inc., Ormond Beach, FL (US)

(72) Inventor: Jeffrey A. Boccaccio, Ormond Beach, FL (US)

(73) Assignee: InVisions Technology Int. Inc., Ormond Beach, FL (US)

(21) Appl. No.: 16/250,350

(22) Filed: Jan. 17, 2019

Related U.S. Application Data
(60) Provisional application No. 62/618,148, filed on Jan. 17, 2018.

(51) Int. Cl. H04N 7/10; H04N 7/015

(52) U.S. Cl. CPC H04N 7/102; H04N 7/015

(57) ABSTRACT

A system, method, and apparatus for enhancing data transmissions along a cable. The invention may be used in a variety of applications, including HDMI cables. In the HDMI paradigm, a high-speed digital equalizer is used to adjust signal gains across the eight signal carrying lines (the three TMDS data channel pairs and the one TMDS clock signal pair). The inventive device is preferably placed at the sink end of the HDMI cable and in a preferred embodiment is actually incorporated into the sink connector on the HDMI cable itself. A bias tee network is applied to the TMDS lines before they are fed into the digital equalizer. The output of the digital equalizer is fed through an attenuation network to limit the peak output signal gain.

### CROSS-REFERENCE TO RELATED APPLICATION

This application claims the benefit of priority of U.S. provisional application No. 62/618,148, filed Jan. 17, 2018, the contents of which are herein incorporated by reference.

### BACKGROUND OF THE INVENTION

The present invention relates to the field of communications. More specifically, the invention comprises devices and methods for increasing transmission speed and accuracy over cable interfaces.

The present invention is designed to operate as part of a cable interface connecting a source device to a sink device. As an example, an HDMI cable may be used to connect a satellite receiver to a television. In this context the “source” is the satellite receiver and the “sink” is the television.

The currently-used HDMI standards present challenges for cable designers, principally owing to the data rates required. This challenge is expected to grow much worse with the deployment of “8K UHD HDMI”—the coming “ultra high definition” standard.

The present invention has application beyond HDMI cable interfaces. However, as the exemplary embodiments disclosed in this specification pertain to HDMI, the reader may benefit from some background understanding specific to HDMI. “HDMI” stands for “High-Definition Multimedia Interface.” Cables falling under the HDMI standard are often used to connect a video source to a video display device. One intention of the standard is to provide a single cable that carries everything needed. Thus, HDMI cables carry both video and audio signals.

However, the HDMI standard encompasses things beyond the current just video and audio information. While there is some variability within the defined HDMI standards, most HDMI cables carry: (1) high-definition digital video data, (2) digital audio data, (3) CEC (consumer electronics connection) command data, (4) Ethernet data, (5) digital content encryption data, and (5) component “handshake” data.

Some of the information is intended to pass only in one direction—such as digital video data passing from the source to the sink. Other information under the HDMI standard is intended to be bidirectional—meaning that it travels from the source to the sink and from the sink to the source. Component handshake data is an example of bidirectional information.

As stated previously, the HDMI standards allow all these connections to be made via a single integrated cable. FIG. 1 shows a schematic representation of a prior art HDMI cable 14 connecting between a source IO and a sink 12. An HDMI cable typically includes an integrated conductor bundle having a termination on each end. The conductor bundle includes multiple isolated conductors within a single protective jacket. The termination provides a transition for the conductor bundle to an HDMI-standard connector.

The HDMI-standard connection includes numerous pins. The pins actually make the electrical connection when the connector is plugged into an HDMI receptacle. The pins 14 of an HDMI connector are biased to provide a clamping force. They maintain a clamping force when connector 12 is plugged into an HDMI receptacle, thereby making contact with the electrical “lands” provided on the receptacle.

A “source” can be any type of device that transmits data for use by an HDMI cable. Examples include satellite or cable set top boxes, DVD players, Apple TV units, audio processing units, video recorders, AVR's, etc. The sink is usually some kind of display device, with the term “display device” referring to a video display that may or may not include audio capability as well. A good example is a high-definition television. The reader should bear in mind that a “display device” is only one type of device that might use an HDMI cable. Since the HDMI cable provides video data, audio data, and auxiliary conduits facilitating digital communication between the devices, it is often the only connection needed. This “one wire” approach is often touted as HDMI's main benefit.

FIG. 1 shows exemplary prior art electrical connections that are actually made by an HDMI Type A cable. Source connector 16 receives inputs on 19 different pins (numbered 1 through 19 in the view). An electrical connection is made to corresponding pins (1-19) on sink connector 18. Pins 1-12 carry the high-definition video signals. The video signals are carried in four “channels,” commonly referred to as the red, green, blue, and clock channels. The data transmitted through the device is agnostic to any data including the transition-minimized differential signaling (“TMDS”) used for each of these channels.

“Transition-minimized” (“TM”) refers to a technique of bit encoding that clusters 1s and Os together in order to minimize 1 to O or O to 1 transitions. A digital transition creates an edge of a square wave. This edge creates unwanted harmonic energy and can create electromagnetic interference. TM encoding minimizes these transitions.

“Differential signaling” (“OS”) refers to a technique of sending two complementary signals on two paired wires. The polarity of the two (DC) signals is opposite. The two signals are typically fed into a subtractor on the receiving end. This device has the effect of doubling the amplitude of the desired signal while canceling any unwanted noise picked up by the transmitting lines. TMDS is the combination of “TM” and “OS” signaling. Information is carried by the voltage difference between the two lines.

The “TMDS D2” channel shown in FIG. 1 is carried on pins 1-3. Pin 1 is the positive half of the differential signal. Pin 3 is the negative half. Pin 2 is connected to a shield surrounding the positive and negative lines.

The “TMDS D1 ” channel shown in FIG. 1 is carried on Pin 4-6. Pin 4 is the positive half of this differential signal while pin 6 carries the negative half. Pin 5 is connected to a shield. The “TMDS D0” channel shown in FIG. 1 is carried on Pin 7-9. Pin 7 carries the positive half of this signal while pin 9 carries the negative half. Pin 8 is again a shield. The “TMDS clock” channel carries the clock signal for the video feed or can also be used as a fourth data channel for any future expansion of the interface on pins 10 and 12. Pin 11 is a shield.

The reader will thereby appreciate that the HDMI standard carries the primary data on eight conductors (currently four TMDS pairs). There are three separate TMDS channels for the additive primary colors used in creating displayed video images. Under Rev 2.0, the standard uses 3 pairs, plus a clock under TMDS. However, under Rev 2.1 the standard may permit 4 pairs, where the clock channel is replaced by a 4^{th} video channel under 16b18b. Under the existing standards, these signals are transmitted at a very high rate (6 GHz).

The remaining pins in the prior art HDMI cable connectors serve additional well-known functions. Pin 13 carries a Consumer Electronics Connection (“CEC”) data. CEC data allows one HDMI-compatible device to control another. For example, a user can employ a remote control for a television to also control a DVD player using commands sent over the CEC.

Pins 14 and 19 in conjunction serve as an Ethernet connection. Pin 14 is the positive portion of the pair and Pin 19 is the negative portion (as well as serving an additional function).

Pins 15 and 16 are used for a Display Data Channel (“DDC”) that operates over an inter-integrated circuit (I²C) bus. The I²C bus is in fact significant to some embodiments of the present invention as it is may be used to carry important signals between the source and the sink.

Pin 17 provides a ground connection, while Pin 18 provides +5V DC. Pin 19 serves as the negative pair for an Ethernet connection when such a connection is in use. In addition, Pin 19 provides a “hot plug detect” function. The source device monitors this pin. When a receiving device is initially plugged into the cable, the source device will detect a 5 V signal on Pin 19. This hot plug detection may be used to initiate an exchange of data between the source and sink devices.

Under the HDMI Revision 2.0b standard the TMDS aggregate bandwidth increased from 10.2 gigabits per second (Gbps) to 18 Gbps. The rate is expected to increase to 48 Gbps as the “8K” standard is deployed. The industry expects this data rate to be sustained in a cable with a length of 5 to 20 meters using multiple gauge conductors.

It is well known that existing HDMI cables suffer from insertion losses and other undesired phenomena. In order to compensate for these losses, sink manufacturers (primarily television manufacturers) of 4K-compatible devices apply an internal equalization function to the incoming signals received over an HDMI cable. This compensation is referred to as the “reference equalization,” that is a built-in compensating equalization within the receiving side of the sink.

FIG. 2 presents a gain versus frequency plot for the prior art reference equalization 20. The reader will note that the signal gain peaks at 12 dB around 3 GHz. It rolls off to 4 dB at 6 GHz. While it is possible to provide an external equalization device, the 12 dB of internal gain in the reference equalization 20 presents a problem. Adding additional external equalization will eventually saturate the input and produce data errors. Under HDMI Rev 2.0b a loss of content protection is also possible.

New displays are also appearing with input equalization exceeding that of the reference equalization. These manufacturers consider their internal equalization proprietary and they do not publish its details. This fact presents a problem for external equalization devices.

In addition HDMI's Display Data Channel (“DDC” carried on pins 15 and 16) is expected to carry increased traffic under the new HDMI revisions. The new traffic relates to new scrambling techniques, changes in the way content protection is controlled, and error correction.

As can be seen, there is a need for an apparatus and method for providing external equalization that takes these constraints into account.

### SUMMARY OF THE INVENTION

In one aspect of the present invention a system and method for enhancing data transmissions along a cable is disclosed. The invention may be used in a variety of applications, including HDMI cables. In the HDMI paradigm, a high-speed digital equalizer is used to adjust signal gains across the eight signal carrying lines (the three TMDS data channel pairs and the one TMDS clock signal pair). The inventive device is preferably placed at the sink end of the HDMI cable and in a preferred embodiment is actually incorporated into the sink connector on the HDMI cable itself.

A bias tee network is applied to the TMDS lines before they are fed into the digital equalizer. The output of the digital equalizer is fed through an attenuation network to limit the peak output signal gain. The device passes the HDMI reference equalization signal without undue disturbance. An accelerator is applied to the Display Data Channel. Other HDMI inputs (such as the “hot plug” signal) may simply be fed through without modification.

These and other features, aspects and advantages of the present invention will become better understood with reference to the following drawings, description and claims.

### BRIEF DESCRIPTION OF THE DRAWINGS

FIG. 1 is a schematic view, showing the signals carried by an HDMI cable.

FIG. 2 is a plot of gain versus frequency for an HDMI cable.

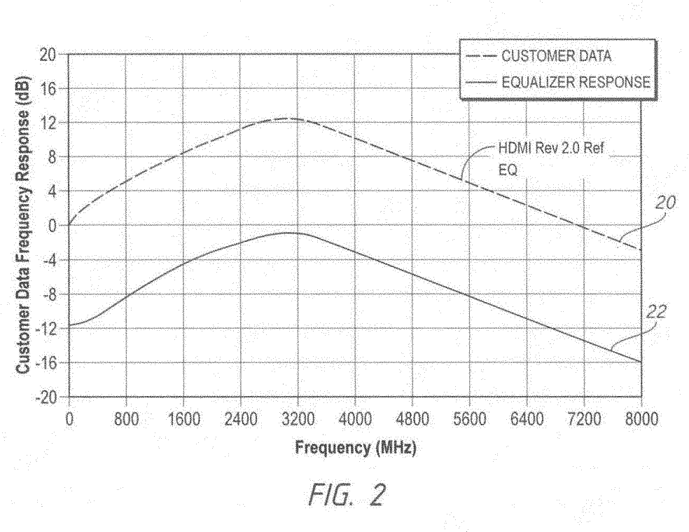

FIG. 3 is a plot of gain versus frequency for the inventive system.

FIG. 4 is a schematic view, showing an exemplary embodiment of the present invention.

FIG. 5 is a schematic view, showing a portion of an exemplary bias tee network.

FIG. 6 is a schematic view, showing a portion of an exemplary attenuation network.

FIG. 7a depicts the insertion loss over a typical long HDMI transmission line.

FIG. 7b depicts a representation of HDMI's reference corrective equalizer that resides inside the sink superimposed over the DUT curve.

FIG. 7c demonstrates the challenge to apply corrective cable equalization over the entire spectrum.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

HDMI will be used as the paradigm for the following descriptions of the exemplary embodiments of the invention. However, the reader should bear in mind that the invention may be applied to non-HDMI systems.

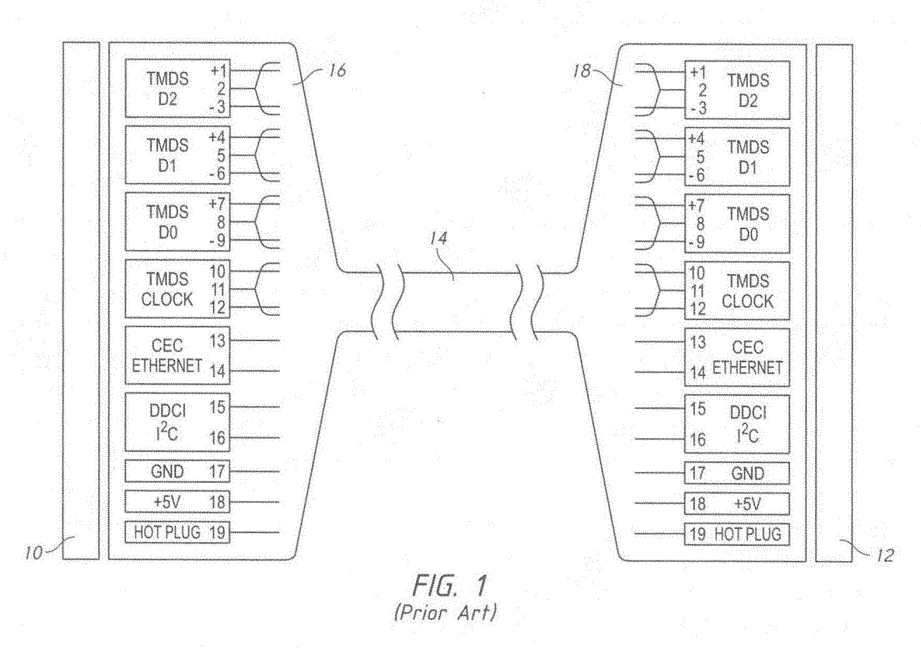

FIG. 1 shows the various components of an HDMI cable. The four TMDS channels (clock, D0, D1, and D2) must carry the accelerated transmission rates in the new HDMI standards. As explained previously, the Display Data Channel (“DDC”) is also expected to carry an accelerated transmission rate.

The TMDS channels comprise eight conductors arranged in four pairs. The actual data rate is stated for the three “signal channels” (D0, D1, and D2). A total data rate of 18 Gbps means 6 Gbps on each of the three channels. Likewise, the anticipated standard with 48 Gbps total rate means a 12 Gbps rate on each of 4 channels.

An external equalization system is needed—with the term “external” meaning external to the source and sink devices. Existing HDMI signal processing hardware is unfortunately not suited to these very high data rates. The present inventor looked to other fields to find such hardware and then built an integrating system to allow this other hardware to function within the HDMI paradigm.

Very high speed signal processors do exist in the field of current mode logic (“CML”) outside of HDMI. Some existing CML processors are designed around the 40GBASE-CR4/SR4 Ethernet and Quad Data Rate (QDR) (InfiniBand) and miniSAS transmission standards. For example, 40GBASE can support ethernet frame transmission rates at 40 Gbps and 100 Gbps. 40GBASE hardware includes signal equalization devices that are fast enough to operate under the new HDMI standards, but they are not designed for the HDMI standard and will not function adequately in an HDMI system without the addition of other hardware.

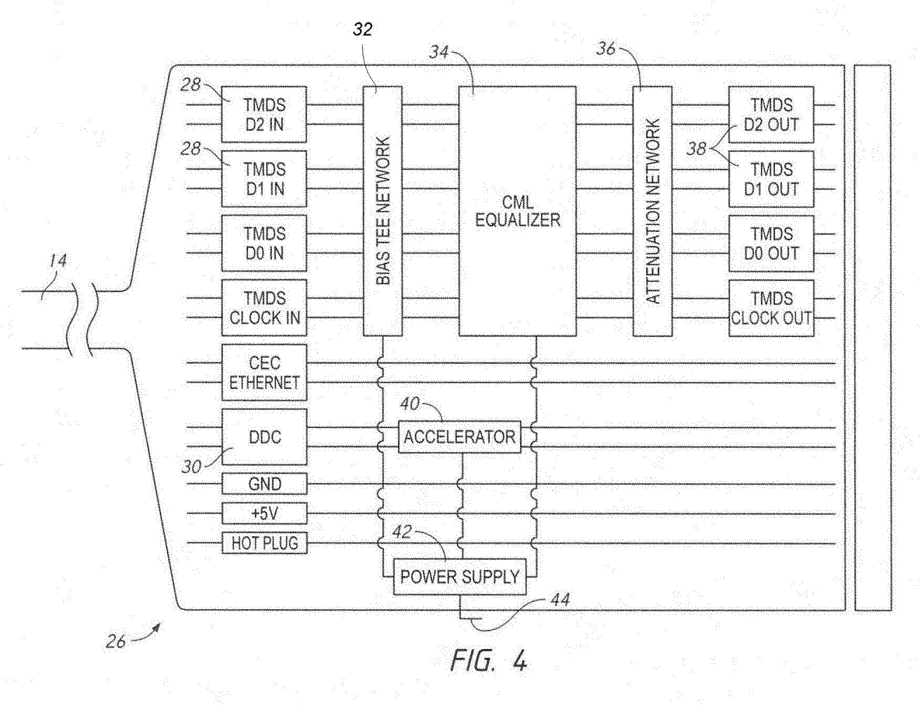

The present invention includes additional hardware configured to adapt the non-HDMI signal processing hardware to the HDMI environment. FIG. 4 provides a schematic depiction of a preferred embodiment. In this version, signal processor 26 is made small enough to be included in the HDMI sink connector 18. The reader will note that HDMI cable 14 feeds into this sink connector as for the prior art. The sink connector connects to sink device 12. In other words, the inventive signal processor 26 resides at the distal end of the HDMI cable just before the signal is fed into the sink device, or alternatively as an adapter between a sink end of the HDMI cable and an input connector of the sink device.

Input TMDS signals 28 are altered by the inventive processor. Input DDC signal 30 is preferably also altered. The other HDMI signals (such as the hot plug line and ground line) may simply be passed through without alteration. In a preferred embodiment, a CML equalizer 34 actually performs the equalization function.

The challenge for corrective equalization for HDMI transmission lines requires a unique understanding of how the interface functions under real life circumstances along with the physical characteristics for any copper transmission line. In addition, bandwidths for this interface have continually increased beginning from its inception to current day operation. This has forced any bandwidth recovery device to operate inside a huge frequency spectrum while at the same time have to compensate for any additional internal equalization specified for each said revision.

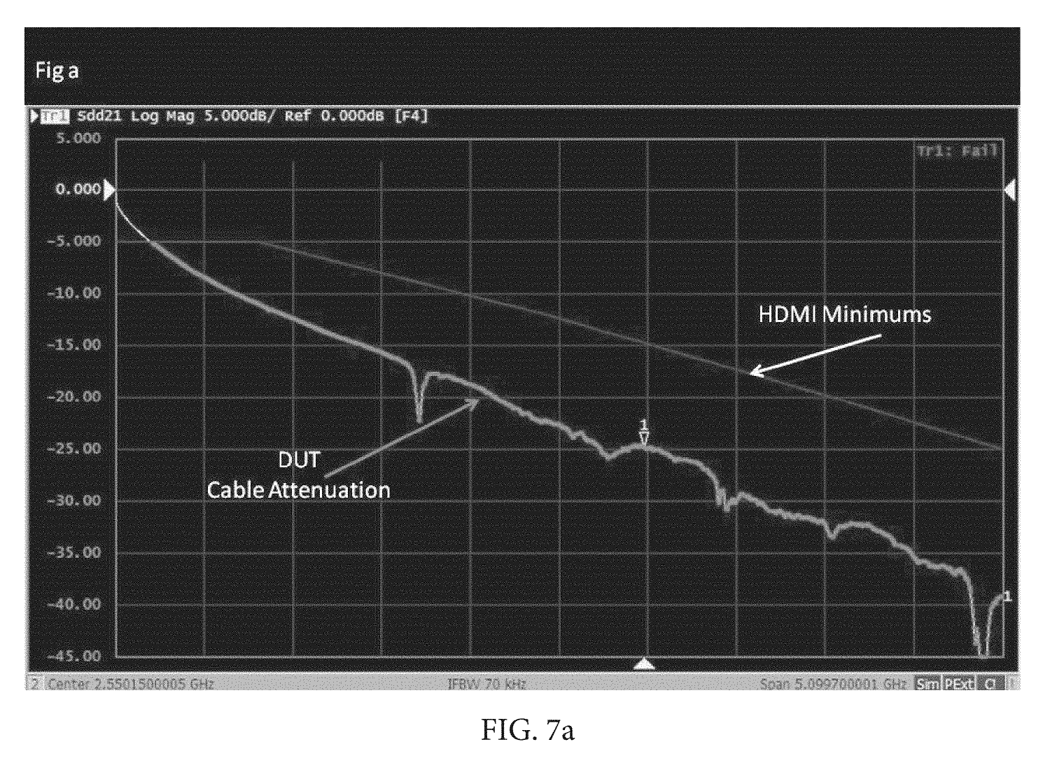

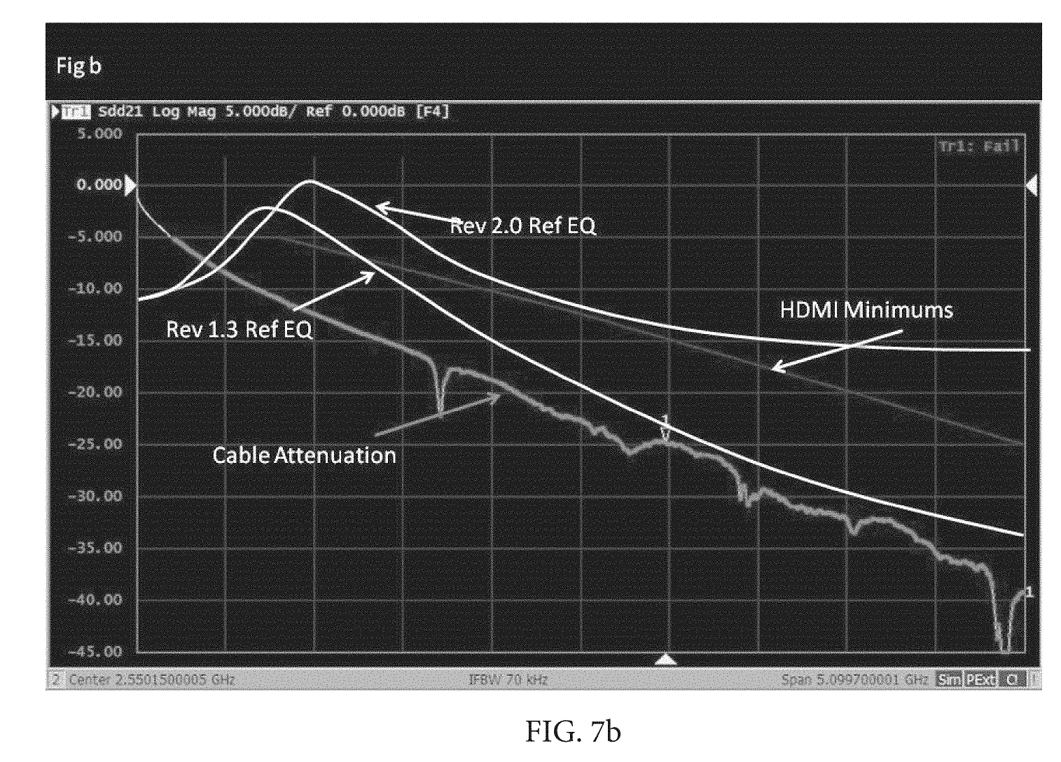

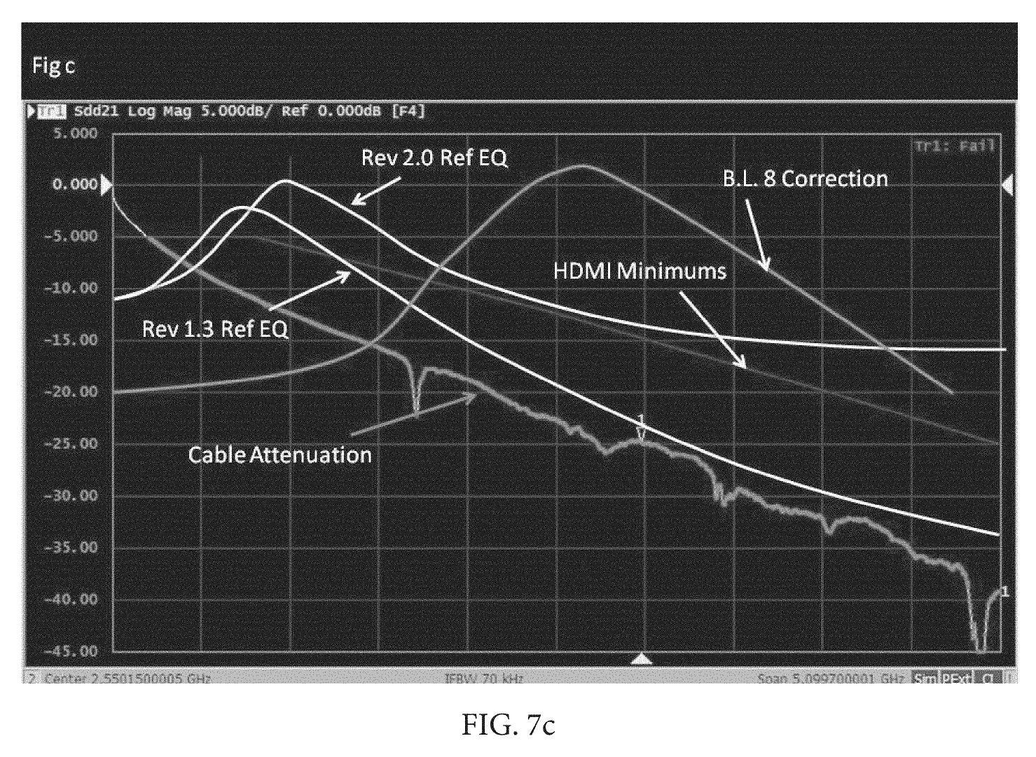

FIG. 7a depicts the insertion loss over a typical long HDMI transmission line. By way of example, the DUT (device ender test) rolls off at a continuous rate as the frequency response increases. The limit line represents the absolute maximum loss in order for HDMI to function. The goal is to provide enough gain to bring the cables response above the limit line depending on each revision. In this example we are correcting for data rates under Rev 2.0 for 6 GHz.

FIG. 7b depicts a representation of HDMI's reference corrective equalizer that resides inside the sink superimposed over the DUT curve.

FIG. 7c demonstrates the challenge to apply corrective cable equalization over the entire spectrum. If normal typical equalization is used the increases for Rev 1.3 and 2.0 would have been saturated yielding a high error rate and loss of signal.

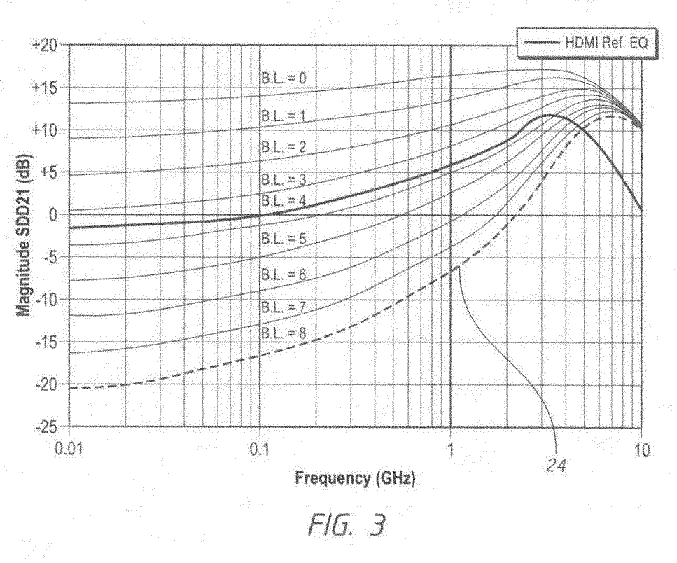

By way of internal programming of the CML equalizer, the device can be made to shape a corrective curve for the overall cables response without being affected from the addition equalization scheduled for each revision. The example used here was curve B.L. 8 from FIG. 3 to compensate for 6 GHz.

Programming is accomplished by way of 4 control ports requiring an analog Rail Voltage, Analog Float Voltage, and an Analog Ground. This configuration allows for the programming to be executed by way of passive devices such as switches, pull up resistors pulls down resistors or can be software controlled by way of an additional micro processor. By manipulating these analog states 8 discrete EQ settings can be utilized.

As per FIG. 3's response curves one can understand the bandwidth dynamic of the design allowing for cable correction for HDMI transmission from short and small gauge to long and high gauge.

This equalizer is preferably a device designed to operate under the 40GBASE-CR4/SR4 standard, though equalizers designed to operate under other standards may be suitable as well. Though it is referred to as a “CML” equalizer in this single example the reader should bear in mind that other types of equalizers might be used in other examples.

Regulated power source 42 is provided (either as an internal or external device). The power supply supplies suitable voltages to bias tee network 32, equalizer 34, and accelerator 40, each of which may have different voltage requirements. The input TMDS signals 28 are fed into bias tee network 32 before going into CML equalizer 34. The individual circuits within this bias tee network (which will be explained in more detail subsequently) act as “pull ups” pulling up the data on the TMDS lines before the data enters the equalizer (as well as providing a filtration function). By way of non-limiting example, the power source 42 may be provided via a universal serial bus (USB) cable and a powered USB connector.

The output of CML equalizer 34 may exceed the desired maximum peak-to-peak voltage for an HDMI signal. Accordingly, additional hardware is provided on the output side. An attenuation network 36 alters the signal coming out of CML equalizer 34. The result is TMDS output signal 38.

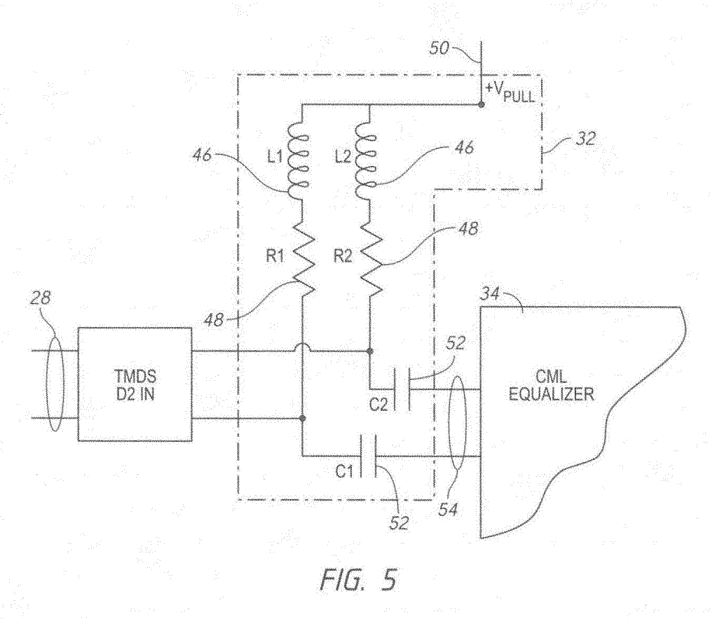

FIG. 5 shows details of an exemplary embodiment for bias tee network 32. Only a portion of the bias tee network is shown (just the portion that is applied to the D2 signal pair). Those skilled in the art will recognize the structure of a traditional “ bias tee” applied to each input TMDS signal 28. Pull-up voltage 50 is applied to the “DC” side of the bias tee. The “RF” side of the bias tee feeds into CML equalizer 34 (as modified TMDS input signal 54). Each bias tee includes a resistor 48 (RI, R2), an inductor 46 (LI, L2), and a capacitor 52 (CI, C2).

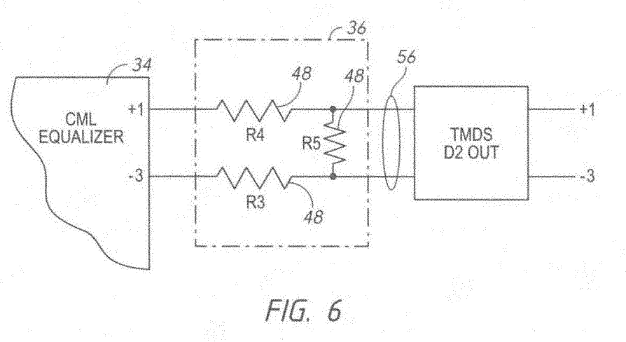

FIG. 6 shows details of an exemplary embodiment of attenuation network 36.

Again, only a portion of the network is shown (the portion applied to the D2 signal pair). A resistor 48 is included for each of the output lines (R4, R3). In addition, a resistor is applied across the two output lines (R5). The signal emerging from the attenuation network is labeled as modified TMDS output signal 56.

Returning now to FIG. 4, the inventive signal processor 26, if used properly, can compensate for losses in any long HDMI cable while not disrupting the HDMI reference equalization. FIG. 3 depicts both the reference equalization signal (“HDMI Rev 2.0 Ref EQ”) and the frequency distribution for the present invention. The reader will note that the reference equalization signal peaks about 12 dB at 3 GHz and rolls off to 8 dB at 6 GHz. The reader will recall that 6 GHz will be the desired region of good gain for the new 18 Gbps (6 Gbps per channel) HDMI standard.

FIG. 3 also depicts different responses for the inventive signal processor at different Boost Levels (“B.L.”). For B.L.=8, the correction used in the response is scaled low at 3 GHz and peaks substantially at 6 GHz. Further, the correction provided by the inventive system is sustained between 6 and 12 GHz—meaning that it will work well for all the currently anticipated HDMI transmission rates.

The inventive system provides up to 33 dB of gain at 6 GHz whereas at 3 GHz the gain is only 4 dB, as seen in the equalization response curve 24, depicted for boost level 8.

Thus, the HDMI reference equalization signal is not over boosted. However, the boost provided in the desired frequency ranges is sufficient to ensure reliable operation without the need to individually program the equalization function to suit the parameters of an individual cable.

Additional features of the inventive system include:

The ability to operate at frequencies as low as 74 MHz per channel;

The ability to operate at frequencies as high as 12 GHz per channel;

The output attenuation network limits the output on the TMDS lines to appropriate HDMI levels ;

Internal features of the equalizer 34 may also serve to limit output voltage;

The accelerator applied to the DDC channel improves the integrity of that channel. The accelerator, originally designed by Philips, compensates for the capacitive loading that occurs on the wires in the cable. The I2C protocol was intended to be used on PCB traces and not long wires. As the length of the wire is extended the capacitive loading increases. The accelerator corrects for this high capacitive loading for long wire lengths;

Shield conductors may be appropriately tied from the input side to the output side, as are ground conductors (not shown in the views);

The overall form factor of the inventive processor may be made small enough to fit into an HDMI connector footprint by using multi-layer PC boards and other techniques for space efficiency; and

The invention may be used with non-HDMI cables such as USB 3.1C, Virtual Reality, and Display Port systems.

Although the preceding descriptions contain significant detail, they should not be construed as limiting the scope of the invention but rather as providing illustrations of the preferred embodiments of the invention. Those skilled in the art will know that many other variations are possible without departing from the scope of the invention. Accordingly, the scope of the invention should properly be determined with respect to the claims ultimately presented rather than the examples given.

What is claimed is:

1. A cable interface for enhancing data transmission of a cable operatively connected between a source device and a sink device, the cable interface comprising:
a signal processor configured to compensate for a signal loss along a length of the cable and maintain a reference equalization for a plurality of transition-minimized differential signaling (TMDS) channels carried by the cable.

2. The cable interface of claim 1, the signal processor further comprising:
a high-speed digital equalizer configured to adjust a signal gains across the plurality of TMDS channels; and
a bias tee network interposed between the plurality of TMDS channels and the high speed digital equalizer, the bias tee network configured to apply a pull up voltage to each of the plurality TMDS channels.

3. The cable interface of claim 2, the signal processor further comprising:
an attenuation network operatively connected to an output of the high speed digital equalizer, wherein the attenuation network limits the TMDS channels to a specification voltage level.

4. The cable interface of claim 3, wherein the specification is a high-definition multimedia interface (HDMI) standard.

5. The cable interface of claim 2, further comprising:
a power source operatively connected to power the equalizer and the bias tee network.

6. The cable interface of claim 5, further comprising:
a display data channel (DDC) operating on an inter-integrated circuit (I2C) bus.

7. The cable interface of claim 5, further comprising:
an accelerator configured to compensate for a capacitive loading in the cable.

8. The cable interface of claim 6, wherein the power source is operatively connected to the accelerator.

9. The cable interface of claim 1, wherein the signal processor is integrated in a sink end of the cable.

10. The cable interface of claim 1, wherein the signal processor is integrated in an adapter, configured to be coupled between the cable and an input connector of the sink device.

11. The cable interface of claim 1, wherein the signal processor provides a positive gain between about 2 GHz and about 12 Ghz.

12. The cable interface of claim 1, wherein the signal processor provides a peak gain of about +12 dB at a frequency of about 5 GHZ and about 8 GHz.

13. A cable interface for enhancing data transmission of a cable operatively connected between a source device and a sink device, the cable interface comprising:
a signal processor operatively connected to a sink end of a data transmission cable configured to compensate for a signal loss along a length of the cable and maintain a reference equalization for a plurality of data transmission channels carried by the cable;
a bias tee network configured to network interposed between the plurality of data transmission channels and the high speed digital equalizer, the bias tee network configured to apply a pull up voltage to each of the plurality of data transmission channels; and
an attenuation network operatively connected to an output of the high speed digital equalizer, wherein the attenuation network limits the plurality of data transmission channels to a specification voltage level.

14. The cable interface of claim 13, further comprising:
a power source operatively connected to power the signal processor and the bias tee network.

15. The cable interface of claim 13, wherein the signal processor, bias tee network, and attenuation network are carried within a connector housing on a sink end of the cable.

16. The cable interface of claim 13, wherein the signal processor, bias tee network, and attenuation network are carried within an adapter, wherein the adapter is configured to be connected between a sink end of the cable and an input connector of the sink.
